(19) United States
(12) Patent Application Publication
(10) Pub. No.: US 2012/0270196 A1
(43) Pub. Date: Oct. 25, 2012

(54) SYSTEMS AND METHODS FOR VIRTUAL WOUND MODULES

(75) Inventors: Heather Hettrick, Atlantic Highlands, NJ (US); Daniel Hettrick, Atlantic Highlands, NJ (US); David Austin, Phoenix, MD (US)

(73) Assignee: Applied Computer Education Services, Inc., Irvine, CA (US)

(21) Appl. No.: 13/451,172

(22) Filed: Apr. 19, 2012

Related U.S. Application Data
(60) Provisional application No. 61/477,997, filed on Apr. 21, 2011.

(51) Int. Cl. G09B 23/28

(52) U.S. Cl. 434/262

(57) ABSTRACT

Wound care systems and methods are disclosed that provide users with interactive instruction for chronic wound care. The system presents a visual depiction of a patient with a chronic wound and a visual depiction of wound characteristics, cross-section of the wound and interactive wound care tools. Further, the system presents a visual map having on-screen graphics representing at least one of tissue consistency, tissue texture, tissue temperature, tissue moisture and tissue tenderness for a virtual chronic wound. At least some of the on-screen graphics represent visual cues for the wound care such that a user is provided with a visual indication of the response of the virtual wound to the care the user virtually provides. Administrators can select care modules to build custom training tutorials. In addition, the system tracks the user interaction with the virtual training to provide feedback to the administrator or the user.

This application claims the benefit of priority under 35 U.S.C. §119(e) of U.S. Provisional Application No. 61/477,997, filed on Apr. 21, 2011, and titled “USER INTERFACE FOR VIRTUAL WOUND MODULES”, the entirety of which is hereby incorporated herein by reference to be considered part of this specification.

### BACKGROUND

This invention relates to a virtual training system for training users in the care and treatment of wounds.

Patients in care facilities, such as nursing homes, are often afflicted with chronic wounds. While underlying causes of chronic wounds vary from patient to patient, they tend to occur in patients with poor blood circulation, diabetes, or for other reasons related to a patient's condition. Pressure ulcers (sometimes called ‘bed sores’), for example, can develop in nursing home patients who are confined to bed, and can evolve into chronic wounds. Likewise, for a person with diabetes, a simple foot blister may result in a chronic open sore, serious infection, gangrene, and may even require amputation.

Caregivers need to be educated about proper wound care and prevention. While caregivers can be educated by reading or listening to educational materials, a more effective training and reinforcement occurs when the caregiver actually performs the evaluation and treatment steps. However, when caregivers learn how to evaluate and treat wounds on human patients, the patients are exposed to unnecessary risks if the evaluation or treatment is incorrect. To avoid this risk to patients, caregivers learn wound care techniques by evaluating and treating virtual patients through a training system and method comprising an interactive graphical user interface.

### SUMMARY

According to one embodiment, a virtual wound care treatment system includes computer hardware, operating software, applications software, and wound care applications comprising a virtual wound care graphical user interface (GUI). In one embodiment the user is the learner. The system provides the learner with an introduction to the wound and its underlying cause, an interactive question and answer session, additional instructional video lessons and downloadable educational documents, and a quiz. Wound care applications can provide interactive virtual assessments and treatments/interventions for diabetic foot ulcers, ulcers as a result of peripheral arterial disease, pressure ulcers, ulcers as a result of chronic venous insufficiency, and the like. Other wound care applications include skin assessment, assessment of wounds present on admission, the Bates Wound Assessment Tool©, and the like.

During the interactive question and answer session, the learner is provided with a patient history and record, a series of questions and instructions to walk the user through the proper assessments and treatments/interventions of the wound, a graphical depiction of the wound, a gauge panel, a wound panel, and an action panel.

The action panel provides the learner with diagnostic tools, examination tools, medicines, dressings, and adjunctive modalities. The application instructs the learner to select and pick up the virtual devices from the action panel and apply them to the virtual wound. This is a realistic approach to the steps involved and provides a level of desensitization.

The gauge panel represents through a computer, the manual assessment of the patient. For example, gauges represent consistency, texture, temperature, moisture and tenderness/pain associated with the wound and surrounding tissue. As the learner performs the correct wound care steps as instructed by the application, the gauges on the gauge panel change to reflect the findings of the virtual manual assessment.

The wound panel comprises a cross-sectional view of the wound to aid the user in understanding the tissue layers involved in the wound. In another embodiment, the wound panel comprises a perspective view of the wound. As the learner performs the correct assessment and treatment techniques, the system further displays the healing progression of the wound. The visual depiction of both the virtual wound and the cross-section/perspective view of the wound change to reflect the new condition of the tissue.

In one embodiment, the learner is guided through the correct wound assessment. When a learner selects an incorrect procedure, for example, the system prods the learner to make an optimal selection.

In another embodiment, the system permits the learner to follow an incorrect assessment path. The learner can perform actions which lead to a suboptimal outcome for the virtual patient or which lead to a failure to achieve the wound care objectives. In this manner, the learner learns possible consequences of his actions on the virtual patient without harming an actual patient. This additional feedback from the virtual wound care training system provides the learner with additional feedback to enhance the learning process.

In another embodiment, the user is an administrator. The administrator selects performance capsules or wound care scenes within the virtual wound care training system to create a custom lesson for wound care training.

In a further embodiment, the system tracks learner performance data, such as, for example, the length of time the learner viewed a particular learning module or a identifiable portion thereof, the number of questions the learner answered correctly, the number of times the learner repeated the module, which video lessons the learner selected, which supplemental documents the learner selected or downloaded, any questions within the module that the learner repeated, the number of repetitions, and the like. The administrator, in one embodiment, can use the individual learner statistics to assess the breath and depth of the learner's knowledge. In another embodiment, the administrator, in an academic setting, for example, can use the aggregation of a plurality of learners' statistics to assess the breath and depth of the knowledge of a group of students, to help prepare the students for licensure exams, to determine an assignment which is weighted depending on data usage, or the like.

Certain embodiments relate to a wound care system for providing users with interactive instruction for chronic wound care by presenting a visual depiction of a patient with a chronic wound and a visual depiction of wound characteristics, a cross-section of the wound and interactive wound care tools. The system comprises one or more computer processors configured to display a visual map having on-screen graphics representing at least one of tissue consistency, tissue texture, tissue temperature, tissue moisture, and tissue tenderness for a virtual chronic wound, where at least some of the on-screen graphics represent visual cues for wound care such that a user is provided with a visual indication of at least one response of the virtual chronic wound to care the user virtually provides.

According to a number of embodiments, the disclosure relates to a wound care system for providing users with interactive instruction for chronic wound care by presenting a visual depiction of a patient with a chronic wound and a visual depiction of wound characteristics, a cross-section of the wound and interactive wound care tools. The system comprises one or more computer processors configured to display a visual depiction of a virtual patient with a virtual chronic wound, one or more computer processors configured to display a visual depiction of a cross-section of the virtual chronic wound, and one or more computer processors configured to display a visual depiction of a plurality of interactive wound care tools. At least one of the plurality of interactive wound care tools is able to perform care for the virtual chronic wound. The system further comprises one or more computer processors configured to display a visual map having on-screen graphics representing at least one of tissue consistency, tissue texture, tissue temperature, tissue moisture, and tissue tenderness for the virtual chronic wound, where at least some of the on-screen graphics represent visual cues for the virtual chronic wound such that a user is provided with a visual indication of at least one response of the virtual chronic wound to care the user virtually provides.

In accordance with various embodiments, a method for providing a user with training in chronic wound care utilizing one or more computer processors, a memory storage device, a video display, and a user input device is disclosed. The method comprises displaying a visual map having on-screen graphics representing at least one of tissue consistency, tissue texture, tissue temperature, tissue moisture, and tissue tenderness for a virtual chronic wound, where at least some of the on-screen graphics represent visual cues for wound care such that a user is provided with a visual indication of at least one response of the virtual chronic wound to care the user virtually performs.

For purposes of summarizing the disclosure, certain aspects, advantages and novel features of the embodiments have been described herein. It is to be understood that not necessarily all such advantages may be achieved in accordance with any particular embodiment of the invention. Thus, the inventions may be embodied or carried out in a manner that achieves or optimizes one advantage or group of advantages as taught herein without necessarily achieving other advantages as may be taught or suggested herein.

### BRIEF DESCRIPTION OF THE DRAWINGS

Throughout the drawings, reference numbers are re-used to indicate correspondence between referenced elements. The drawings, associated descriptions, and specific implementation are provided to illustrate embodiments of the invention and not to limit the scope of the disclosure.

FIG. 1 is a block diagram illustrating a virtual wound care training system, according to certain embodiments.

FIG. 2 illustrates user or administrator module choices for a virtual wound care training system, according to certain embodiments.

FIG. 3 is an exemplary screen shot of one embodiment of a virtual patient wound care training screen.

FIG. 4 is an exemplary virtual wound care gauge panel, according to certain embodiments.

FIG. 5 is an exemplary virtual wound care wound panel, according to certain embodiments.

FIG. 6 is an exemplary virtual wound care action panel, according to certain embodiments.

FIG. 7 is a flow diagram of an exemplary wound care training process, according to certain embodiments.

FIG. 8 is a flow diagram of another exemplary wound care training process, according to certain embodiments

FIG. 9 is a flow diagram of an administrator process for creating a virtual wound care training module, according to certain embodiments.

FIG. 10 is an exemplary screen shot of an administrator selection screen for building a virtual wound care training module, according to certain embodiments.

FIG. 11 is an exemplary screen shot of a virtual wound care training measures screen for selecting performance criteria, according to certain embodiments.

### DETAILED DESCRIPTION OF THE PREFERRED EMBODIMENT

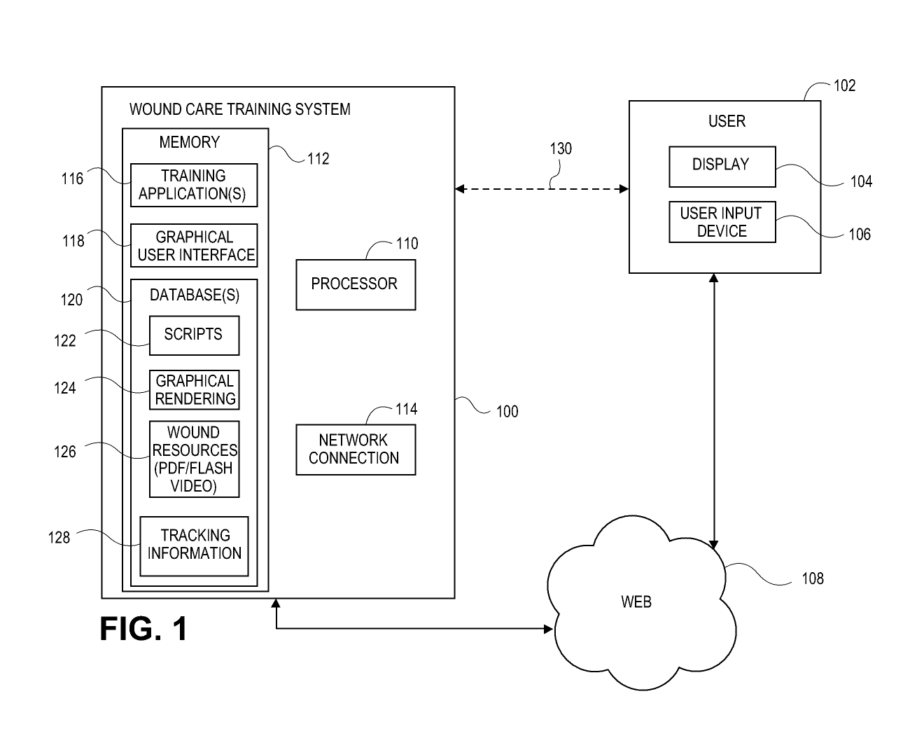

The features of the inventive systems and methods will now be described with reference to the drawings summarized above. FIG. 1 is a block diagram illustrating one embodiment of a virtual wound care training system 100. The system 100 provides interactive wound care training, allows for the generation of custom training sessions, and tracks parameters associated with the use of the interactive training.

A user 102 interfaces with the wound care training system 100. In one embodiment, the user 102 comprises a display 104 and a user input device 106. The display 104 permits the user 102 to view training screens, training module selections, additional wound care information, training quizzes, and the like, from the system 100 and the user input device 106 permits the user 102 to interact with the training system 100 by, for example, selecting wound care tools, selecting the additional wound care information to view, answering questions in a quiz, selecting training modules, selecting tracked parameters, and the like.

The display 104 can be, for example, a stand alone display, a smartphone, a personal digital assistant (PDA), a laptop, a computer, a tablet, or the like. The user input device 106 can be, for example, a mouse, a keyboard, a keypad, a touchpad, a track pad, a touch screen, light pen, trackball, game controller, gamepad, joypad, joy stick, paddle, Wii™ remote, or the like. Thus, the user 102 can use a variety of devices, such as a computer, a laptop, a smartphone, an iPhone, a PDA, Wii™, a game system, a tablet, and the like, to interface with the virtual wound care training system 100.

In one embodiment, the user 102 is a learner who interfaces with the system 100 to learn about chronic wound care through at least one interactive training scene, module, or session. In another embodiment, the user 102 is an administrator who interfaces with the system 100 to create custom training modules or sessions for learners, to select performance measures to track, to review tracked parameters of at least one learner's interactions with the training system 100, and the like.

The virtual wound care training system 100 comprises one or more computers 110, memory 112, and optionally a network connection 114. The computers 110 comprise, by way of example, processors, program logic, or other substrate configurations representing data and instructions, which operate as described herein. In other embodiments, the processors can comprise controller circuitry, processor circuitry, processors, general-purpose single-chip or multi-chip microprocessors, digital signal processors, embedded microprocessors, microcontrollers, and the like.

The memory 112 can comprise one or more logical and/or physical data storage systems for storing data and applications used by the system 100. In an embodiment, the memory 112 comprises at least one training application 116, a graphical user interface program 118 and at least one database 120. FIG. 1 illustrates an exemplary database 120 comprising scripts 122, graphical renderings 124, additional training resources 126, and tracking information 128. In other embodiments, the system 100 comprises different data sources, fewer data sources, or more data sources than the exemplary database 120.

The user 102 runs the training application 116 to begin a wound care training session. The training application 116 through the display 104 and the user input device 106 interfaces the user 102 with the training session. The scripts 122 provide at least one wound care training module or wound care training scene. For example, the scripts 122 can walk the user 102 through the care of a virtual patient's diabetic foot ulcer, a skin assessment of a virtual patient, the chronic care of wounds due to venous insufficiency, how to evaluate a virtual patient's wounds present on admission, the care of a virtual patient's pressure ulcer, and the like.

The graphical renderings 124 provide realistic depictions of the wounds throughout the treatment. In other words, the depiction of the wound changes as the user provides treatment and care. In some embodiments, the wound gradually heals as proper care is applied. In other embodiments, improper care results in no improvement or a worsening of the virtual patients injuries. The graphic renderings stored in the database 124 can be created using programs, such as, for example, Autodesk®, Autodesk Maya, 3D Studio MAX, 3ds Max, and the like, as is known to one of skill in the art from the disclosure herein.

The wound resources database 126 comprises informative documents, in pdf form, for example, and/or videos, such as flash videos, for example, to augment the learner's knowledge. In one example for an embodiment concerning the care of chronic wounds due to venous insufficiency, the training application 116 could make informative documents, such as Chronic Insufficiency Theories; Examination Outline For Chronic Venous Disease; Non-Invasive Vascular Tests; and the like, available to the user 102 and/or video lessons, such as Ankle Brachial Index; Multilayer Compression Wrap; Venous Filling Time Test; and the like available to the user 102. In other embodiments, additional information in other forms, such as, for example, web addresses, jpeg files, and the like, can be used.

The tracking information database 128 comprises performance measures or information tracking the user's interaction with the training system 100. For example, the system 100 could track of the length of time the learner 102 spent on the quiz, the length of time the learner 102 spent on a certain module 116 or portion of a module, such as a scene, the number of correctly or incorrectly answered quiz questions, the number of times the learner 102 views a module or scene, whether the learner 102 repeated questions in the interactive training 116, which supplemental materials 126, such as pdf's or videos, were accessed by the learner 102, and the like.

In one embodiment, the user 102 interfaces directly with the system 100, as indicated by connection 130. In another embodiment, the user 102 interfaces with the system 100 through the Internet 108. In an embodiment, languages and programs such as, for example, HTML5, a language for structuring and presenting content for the World Wide Web, hypertext preprocessor (PHP), a scripting language for producing dynamic web pages, MySQL, a relational database management system that runs as a server providing multi-use access to a number of databases, Adobe® Flash, a multimedia platform to add animation, video, and interactivity to web pages, their predecessors, future versions, or the like, can be used by one of skill in the art of interactive web page development to create the interactive training modules 116 from the disclosure herein.

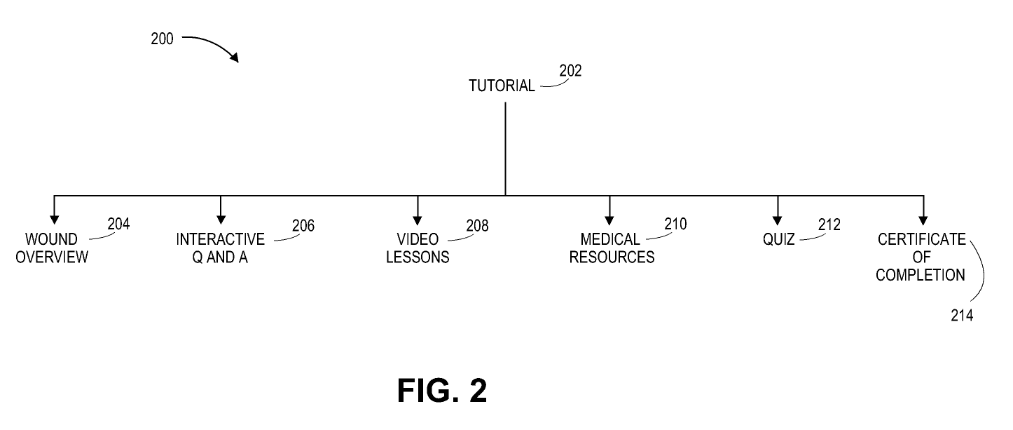

FIG. 2 illustrates an exemplary training module table of contents 200 for the virtual wound care training system 100, according to certain embodiments. In an embodiment, the training module 116 comprises a tutorial 202. In an embodiment, the tutorial 202 can be a video detailing the pathophysiology and relevant statistics pertinent to a wound etiology. In other embodiments, the tutorial 202 can be a narrative, text, or the like.

After viewing the tutorial 202, the user 102 can select, for example, a wound overview 204, an interactive question and answer 206, video lessons 208, medical resources 210, and a quiz 212. The wound overview 204 provides a case study of the virtual patient to be treated and can be stored in the scripts database 122. The video lessons 208 and the medical resources 210 provide additional educational materials pertaining to the wound and are stored in the wound resources database 126.

The quiz 212 asks the user 102 questions pertinent to the treatment of the wound and provides a measure of the user's knowledge. In an embodiment, the quizzes 212 can be stored in the scripts database 122. Once the user 102 has answered a threshold number of questions correctly, the system 100 provides the user 102 with a printable certificate of completion 214. In one embodiment, the threshold number of correct answers is determined by the administrator. In another embodiment, the threshold is predetermined.

The interactive questions and answers 206 provide the user 102 with treatment considerations and treatment options based on the case study of the virtual patient from the wound overview 204. In an embodiment, the interactive questions and answers 206 combine narrative and text prompts to guide the user 102 through a learning experience.

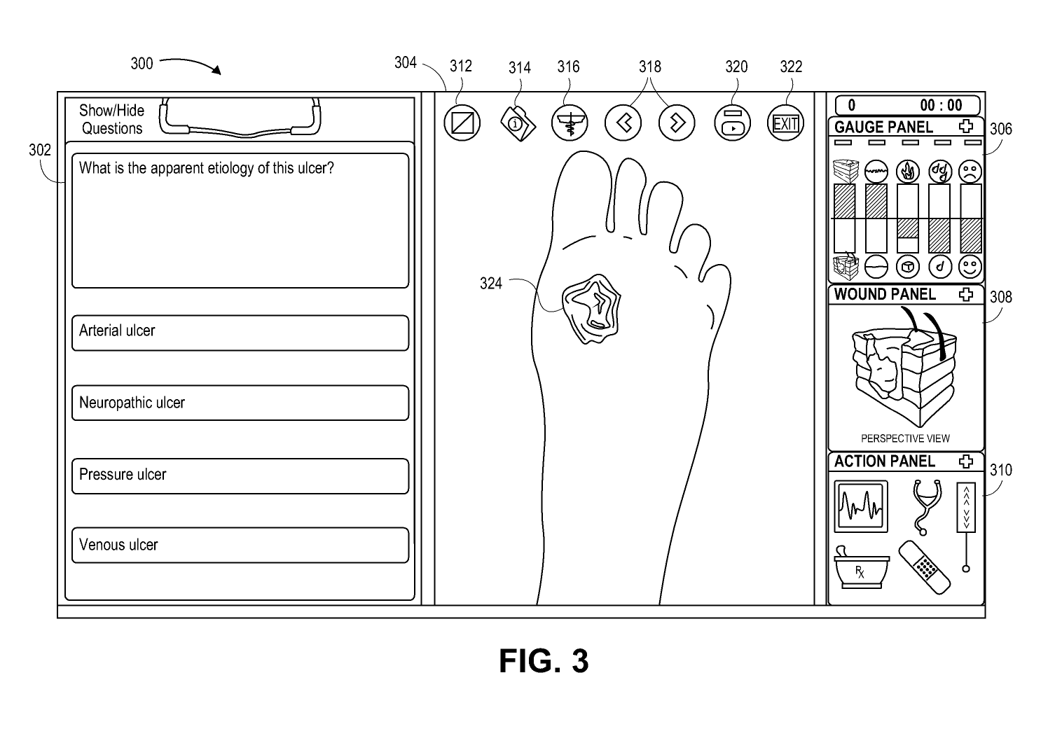

FIG. 3 is an exemplary screen shot of one embodiment of a virtual patient wound care training screen 300 during the interactive question and answer 206. The interactive screen 300 presents the user 102 with visual cues and virtual tools and comprises a plurality of questions and answer choices 302, a patient view 304 including a graphical representation of a patient or a portion thereof, a gauge panel 306, a wound panel 308, and an action panel 310.

The patient view 304, in an embodiment, further comprises a skin color icon 312, a patient folder icon 314, a medical resources icon 316, arrow icons 318, a video icon 320, and an exit icon 322. The skin color icon 312 allows the user 102 to switch between skin colors of the virtual patient 304. This assists the user 102 in understanding the subtle differences skin color has on clinical wound presentation. In an embodiment, the icon 312 permits the user 102 to switch between Caucasian and Non-Caucasian skin colors. In other embodiments, other skin color choices can be presented.

Selecting the patient folder icon 314 displays virtual photos and case history updates as the user 102 progresses through the module 116. The medical resources icon 316 and the video icon 320 allow the user to select and view additional educational resources, such as text articles or flash video, respectively, for example, from the wound resources database 116. The arrow icons 318 permit the user 102 to move forward and backward through the interactive question and answers 206 and the exit icon 322 permits the user 102 to exit the interactive question and answers 206 and return to the table of contents 200. The graphical user interface 118 permits the user 102 to interact with the icons 312, 314, 316, 318, 320, 322 on the interactive screen 300, or the icons on the action panel 310. The graphical user interface 118 can be created, using programs such as, for example, Microsoft™ Visual Studio, or the like, as is known to one of skill in the art from the disclosure herein.

The patient view 304 comprising the graphical representation of the wounded patient or portion thereof, further includes a virtual wound 324. In an embodiment, the graphical representation of the virtual wounds 324 and/or virtual patients 304 are stored in the graphical rendering database 124. Other embodiments may have additional or different icons to permit the user 102 to interact with the wound care training module 116.

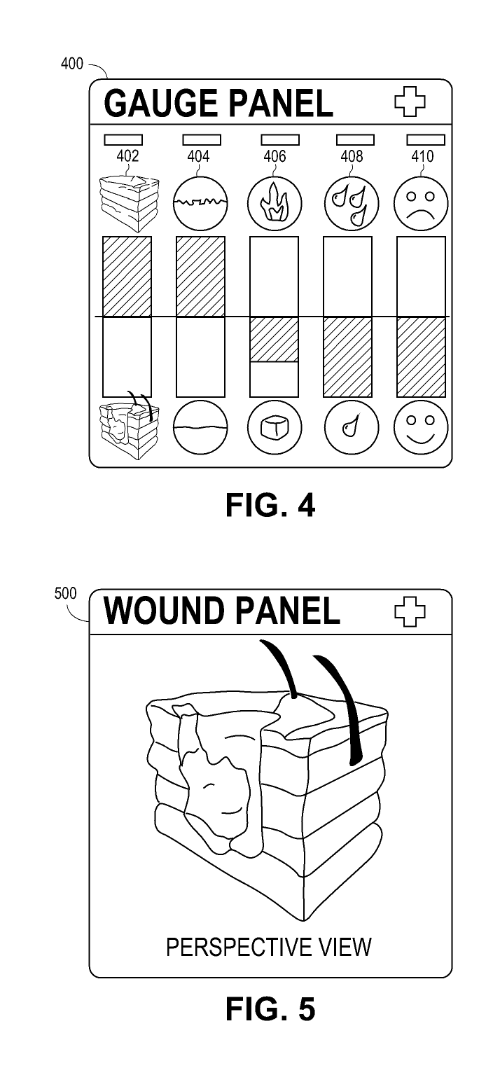

FIG. 4 is an exemplary virtual wound care gauge panel 400, according to certain embodiments. As part of chronic wound care, a caregiver would assess the wound using manual assessment techniques, such as pressing on tissue near the wound/periwound, smelling the wound, assessing for edema, tissue consistency, or texture, and the like. An actual patient would provide tactile, visual, audible, olfactory feedback, for example, in response to the manual assessment techniques. The gauge panel 400 denotes specific findings of the virtual wound tissue 324 during manual assessment techniques. In an embodiment, the gauge panel 400 reflects tissue consistency 402, tissue texture 404, tissue moisture 406, tissue temperature 408 and tenderness 410. The user 102 can view the gauge panel 400 and receive feedback regarding manual assessments of the wound 324. In an embodiment, the gauge panel 400 comprises a sliding scale. In other embodiments, the gauge panel comprises charts, graphs, pie graphs, and the like. The bar below each of the icons 402, 404, 406, 408, 410 in the gauge panel 400 represents a sliding scale, with the middle of the bar representing neutral feedback.

For example, the user 102 may be instructed to palpate the area surrounding the wounded tissue 324. In an actual patient, the user 102 would receive tactile feedback concerning the tissue consistency, texture, temperature, and moisture, for example, and visual or aural feedback from the actual patient concerning the tenderness of the area. The gauge panel 400 provides the user 102 with the results of the palpation in the virtual patient 304. The user 102 bases the subsequent care and treatment of the virtual wound 324, at least in part, on the feedback provided from the gauge panel 400.

In the illustrated embodiment, the gauge panel comprises a tissue consistency gauge 402, a tissue texture gauge 404, a tissue temperature gauge 406, a tissue moisture gauge 408, and a tissue tenderness gauge 410. The gauges 402-410 illustrate a sliding scale to show a tissue characteristic at either end of the scale or at a point in between. The tissue consistency gauge 402 indicates tissue that feels or appears firm versus soft. The tissue texture gauge 404 indicates tissue that feels or appears hard and rough versus soft and smooth. The tissue temperature gauge 406 indicates tissue that feels or appears warm versus cool. The tissue moisture gauge 408 indicates tissue that feels or appears wet versus dry. The tissue tenderness gauge 410 indicates how much pain the patient reports. According to the gauges 402-410 illustrated in FIG. 4, the tissue consistency is firm, as indicated by the tissue consistency gauge 402; the texture is hard and rough, as indicated by the tissue texture gauge 404; the wound temperature is slightly cool, as indicated by the temperature gauge 406; and the moisture content of the wound is dry, as indicated by the tissue moisture gauge 408. The patient reports no pain, as indicated by the tenderness gauge 410.

FIG. 5 is an exemplary virtual wound care wound panel 500, according to certain embodiments. The wound care panel 500 illustrates a cross-section of the wound 324, illustrating the wound depth. In another embodiment, the wound care panel 500 comprises a perspective view of the wound 324. As the treatment progresses, the wound panel 500 reflects the changing depth of the injury. For example, if the user 102 applies the proper treatment, the wound panel 500 will show the wound 324 healing over time. In another embodiment, the wound panel 500 shows the wound 324 degrading or not improving when improper treatment is applied to the virtual patient's wound 324.

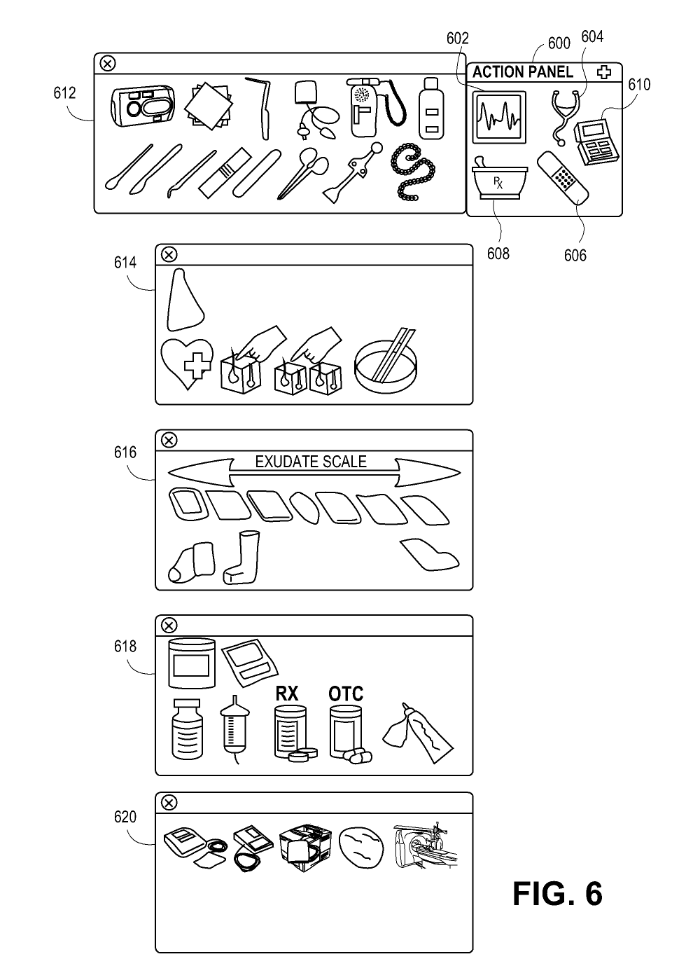

FIG. 6 is an exemplary virtual wound care action panel 600, according to certain embodiments. During the interactive question and answers 206, the user 102 is instructed to interact with the wounded virtual patient 304 using the various tools and instruments housed in the action panel 600. In one embodiment, the action panel 600 comprises exam tools 602, diagnostic tools 604, dressings 606, medicines 608, and adjunctive modalities 610. In an embodiment, when the icon 602, 604, 606, 608, 620 is selected by the user 102, a plurality of additional icons representing items related to the selected icon 602, 604, 606, 608, 620, respectively, is presented.

The exam tools 602 comprise a plurality of examination instruments, such as, by way of example, stethoscope, camera, gauze pads, monofilament, blood pressure cuff, Doppler ultrasound system, saline solution, cotton swab, forceps, ruler, tongue depressor, scissors, irrigation catheter, tape measure, and the like, as illustrated in an exemplary exam tool panel 612. The diagnostic tools 604 comprise a plurality of diagnostic instruments and/or techniques, such as, by way of example, sense odor, check vitals, palpate tissue for temperature, palpate tissue for consistency, culture tissue-Petri dish, and the like, as illustrated in an exemplary diagnostic panel 614. The dressings 606 comprise a plurality of dressing materials and or measurement devices, such as, by way of example, exudate scale, transparent film, hydrogel, hydrocolloid, collagen, hydrofiber, bordered foam, calcium alginate, compression bandage, total contact cast, and the like, as illustrated in an exemplary dressings panel 614. The medicines 608 comprise a plurality of medicines, such as, by way of example, moisture barrier, skin sealant, injectable medicines, intravenous medicines, prescription medicines, over-the-counter medicines, topical enzymes, and the like, as illustrated in an exemplary medicine panel 618. The adjunctive modalities 610 comprise a plurality of therapeutic agents and/or techniques, such as, by way of example, electrical stimulation, ultrasound high frequency imaging, negative wound pressure therapy, biological skin, hyperbaric oxygen therapy, and the like, as illustrated in an exemplary adjunctive modalities panel 620.

As the user 102 assesses and treats the virtual wound 324 using the tools and instruments of the action panel 600, the gauge panel 400 updates to provide wound consistency, texture moisture, temperature, and pain feedback to the user 102. In addition, the graphics comprising the visual depiction of the wound 324 and/or the patient 304, and the wound panel 500 update, as is known to one of skill in the art from the disclosure herein, to reflect the results of the virtual wound treatment.

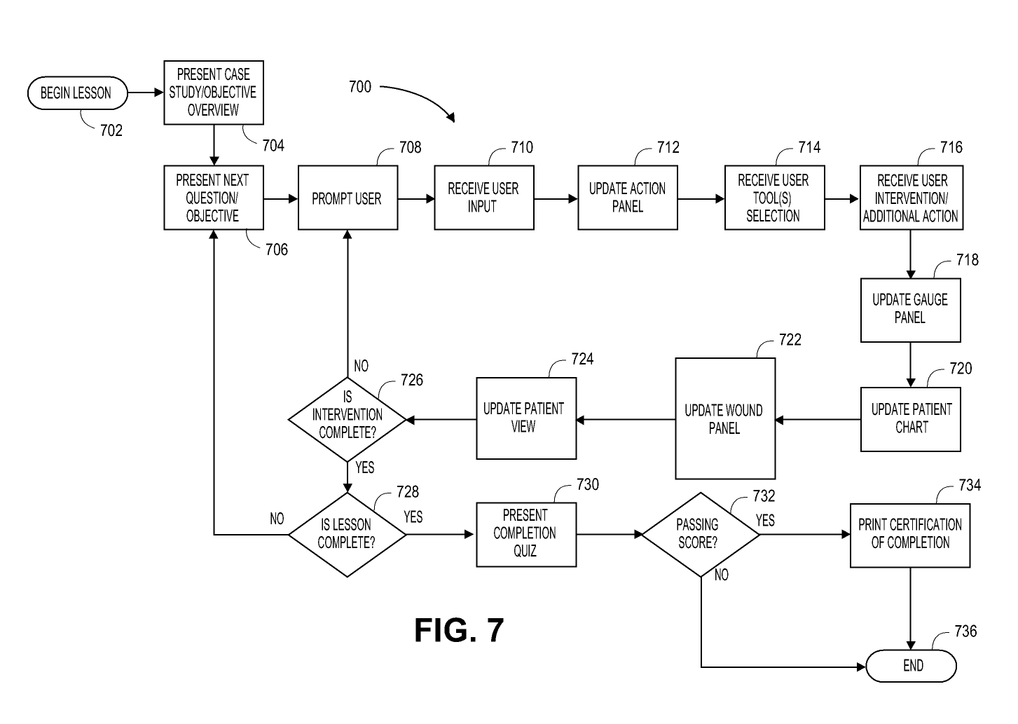

FIG. 7 is a flow diagram of an exemplary wound care training process 700, according to an embodiment. The process 700 begins at block 702, where the lesson begins. At block 704, the process 700 presents the user 102 on the user display 104 with a case study of the virtual patient 304 and/or an objective overview of the training module. For example, the user 102 selects the image of a three-ring medical binder labeled “Medical Record” and the process 700 displays text describing a patient, such as for example, “a 65-year old female presents with a lower left extremity ulcer above the right medial ankle, with swelling in her lower leg, and darkened pigmentation . . . ”. In another example, after the process 700 plays a video relevant to skin assessment, the process 700 displays an objective overview, such as, for example, “you have been asked to perform a thorough skin assessment on a 42-year old male who was seen by his primary care physician for a routine check up. He reports ankle surgery nine months ago following a mountain climbing accident . . . ”

In block 706, the process 700 presents a question for the user 102 to answer and/or an objective for the user 102 to follow.

In block 708, the user 102 is prompted, for example, to select a medicine from the action panel 600, and in block 712, the process 700 receives the user input, such as the selection of the medicine icon 608, from the user input device 106. In block 712 the action panel 600 is updated. In an embodiment, for example, the medicine panel 618 is displayed. In block 714 the user 102 selects an item from the action panel 600, such as a medicine 619, for example, and the process 700 receives the user's selection. In block 716, the process 700 receives additional user input as the user 102 uses the item to perform virtual wound care on the virtual patient 304. For example, the user 102 virtually applies the medicine 619 to the wound 324 by virtually applying the medicine 619 to a gauze pad and virtually placing the gauze pad over a portion of the wound 324, using a mouse, for example, to guide the placement of the gauze pad over the wound 324.

In block 718, the process 700 updates the gauge panel 400 to reflect the results of the user's actions in block 716. In addition, the process 700 updates the patient chart in block 720, updates the wound panel 500 in block 722, and updates the patient view 304 in block 724, to reflect the results of the user's actions on the virtual patient.

In another example, the user 102 is presented with the question “how would you characterize this wound?” in block 706 followed by a plurality of answer choices in block 708. The user 102 using the user input device 106 selects one of the plurality of answers in block 710.

In yet another example, the user 102 is instructed to perform wound irrigation using an angiocatheter in block 706 and prompted in block 708 to select a tool from the action panel 600. The user selects the tools 602 from the action panel 600 and the process 700 displays the tools screen 612 in block 712. The user 102 selects the angiocatheter and virtually irrigates the virtual wound 324 in block 716 by placing the selected tool over the area of the wound 324 to be irrigated. In response to the virtual care, the process 700 revises the graphics in the gauge panel 400 to reflect any changes in the tissue consistency 402, tissue texture 404, tissue moisture 406, tissue temperature 408 and tenderness 410. For example, if the irrigation soothes the wound, then this is shown as a decreased level of pain in the tenderness indicator 410. The process 700 also updates the patient chart in block 720 to reflect the action undertaken by the user 102. For example, the chart may have a new entry with the time and date of the irrigation. In addition, the process 700 revises the wound panel 500 to show how the virtual wound 324 reacted to the virtual care in block 722. For example, the size of the red area surrounding the cross-section of the wound in the wound panel 500 decreases to indicate less irritation after the wound irrigation. Finally, the process 700 revises the graphics in the patient view 304 to reflect the action undertaken by the user 102. For example, the redness of the wound 304 decreases to reflect less soreness after the irrigation.

In block 726, the process 700 determines whether the user's intervention is complete. If not, the process repeats blocks 708-724. For example, if the user 102 did not irrigate the entire wound 324, the process 700 returns to block 708 to prompt the user 102 to repeat the irrigation process. In an embodiment, the process 700 repeats the blocks 708-726 until the user 102 performs the optimal wound care step correctly.

If the wound care step/intervention is complete, the process 700 determines whether the lesson is complete in block 728. If the lesson is not complete, the process 700 returns to block 706, where the next question/objective is presented to the user 102.

If the lesson is complete, the process 700 presents the user 102 with the quiz 212 in block 730 to test the user's knowledge of the lesson. For example, the process presents the user 102 with a plurality of multiple choice questions concerning the lesson. The process 700 receives the user's answer selections and determines the user's score. In an embodiment, the user passes the quiz 212 after answering correctly a predetermined threshold of questions. In block 732, the process 700 determines whether the user passes the quiz 212. If the user 102 passes the quiz 212, the user has the option to print a certificate of completion in block 734 and the process 700 ends at block 736. If the user does not pass the quiz 212, the process ends at block 736 without the option of printing a certificate of completion.

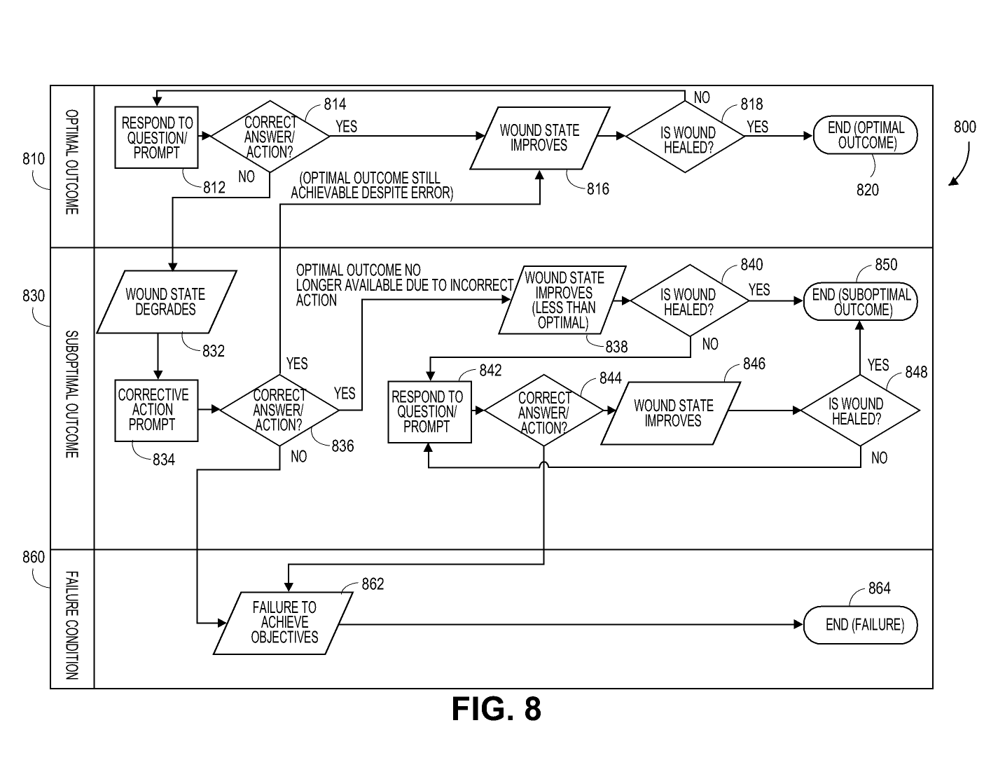

FIG. 8 is a flow diagram of another exemplary wound care training process 800, according to an embodiment. Like the process 700 described above, the process 800 prompts the user 102 to perform virtual wound care on the virtual patient 304. Similar to the process 700, the process 800 prompts the user 102, receives input from the user 102, updates the patient 304, the gauge panel 400, the wound panel 500, and the action panel 600 to reflect the outcome of the user's care on the virtual wound 324. Unlike the process 700, where the blocks 708-724 are repeated until the prompted care is completed correctly, the process 800 permits the user 102 to deviate from an optimal outcome path 810. The process 800 allows the user 102 to choose a suboptimal outcome path 830 or a failure condition 860, and the process 800 revises the graphics of the patient view 304, the gauge panel 400, the wound panel 500, and the action panel 600 accordingly.

Beginning at block 812, the process 800 receives input from the user 102. At block 814, the process 800 determines whether the user 102 supplied the correct input to the prompt or the question. If the user input is correct, the process 800 moves to block 816 in the optimal outcome path 810, where the wound 324 improves. This can be indicated by at least one of updating the gauge panel 400, the wound panel 500 and the patient view 304 to graphically reflect the optimal virtual care.

If the user 102, at block 814, does not supply the correct input to achieve optimal wound care, the process 800 move to the suboptimal outcome path 830. At block 832, the wound state degrades. This can be indicated by at least one of updating the gauge panel 400, the wound panel 500 and the patient view 304 to graphically show the wound 324, for example, not improving, becoming further inflamed, becoming more painful, or the like. In block 834, the process 800 prompts the user 102 to perform corrective action. If the user 102 then performs the proper corrective action, the process 800 moves to the optimal outcome path 810 at block 816.

If the user 102 performs a corrective but not optimal care procedure, the process 800 shows the wound 324 improving in block 838, but not an optimal improvement. This can be indicated by at least one of updating the gauge panel 400, the wound panel 500 and the patient view 304 to graphically show the wound 324 improving somewhat, but not the optimal improvement of block 816.

The process 800 determines whether the virtual wound 324 has healed in block 840. If the wound 324 has healed, the process 800 ends at block 850, with a sub-optimal outcome. If the wound 324 has not healed at block 840, the process 800 prompts the user 102 to perform wound care, and receives the user input in block 842. The process 800 determines whether the user 102 provided the correct answer/care in block 844. If the user 102 provided the correct answer/care, the process 800, in block 846, improves the condition of the wound 304. Again, this can be indicated by at least one of graphically updating the gauge panel 400, the wound panel 500 and the patient view 304.

In block 848, the process 800 determines whether the wound 324 has healed. If the wound 324 is not healed, the process 800 repeats blocks 842-848. When the wound 324 has healed, the process 800 ends at block 850 with a suboptimal outcome.

If the user does not respond with the correct answer in the suboptimal outcome path 830 at block 836 or block 844, the process 800 moves to the failure condition path 860. At block 862, the user 102 has failed to achieve the wound care objectives. At block 864, the process 800 ends with a failure to care properly for the wound 324.

In this embodiment, the process 800 allows the user 102 to learn from mistakes without harming an actual patient. The consequences of improper wound care are reflected in at least one of the gauge panel 400, the wound panel 500, the patient view 304, or the like, which show no improvement or a worsening of the wound 324 as a result of the user's actions.

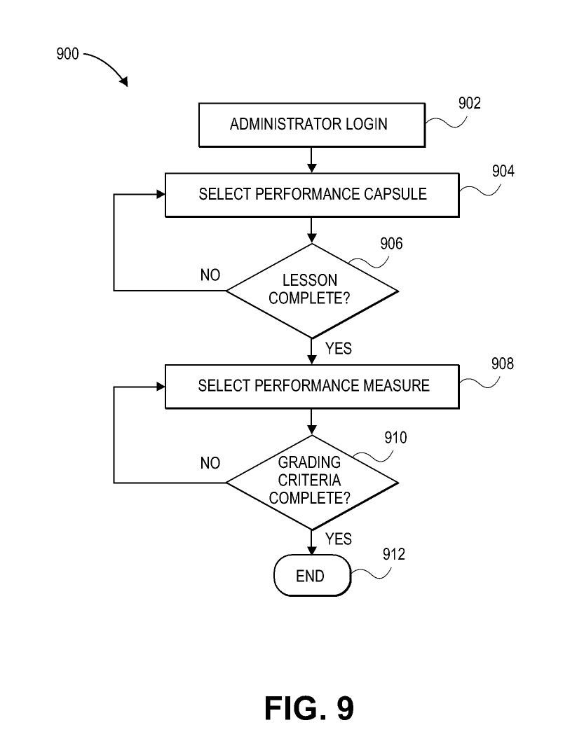

In another embodiment, the user 102 is an administrator and the wound care system 100 tracks various user performance data. The administrator 102 selects at least one virtual wound care scene to build a custom wound care training module. In addition, in an embodiment, the administrator selects tracking data and thresholds to measure learners' performance. FIG. 9 is a flow diagram of an administrator process 900 for creating a virtual wound care training module, according to an embodiment. Beginning at block 902, the administrator 102 logs onto the system 100.

In an embodiment, the training scenes comprise a plurality of performance capsules. At block 904, the process 900 permits the administrator 102 to select at least one performance capsule concerning an aspect of chronic wound care. In another embodiment, the process 900 is not limited to chronic wound care training. The process 900 can permit the administrator 102 to select at least one training/performance capsule concerning an aspect of a training subject.

At block 906, the process 900 inquires whether the training module is complete. If not, the process 900 returns to block 906, where the administrator 102 selects additional training/performance capsules to add to the training lesson.

If the lesson is complete, the process 900 permits the administrator 102 to select performance measures or performance criteria 128 at block 908. The performance measures 128 are indicia that measure how well learners are learning the training presented to them by the system 100. Performance measures 128 can be, for example, the amount of time the learner spent on the training lesson, which supplemental medical resources 124 the learner downloaded, which supplemental video lessons 126 the learner watched, the number of correct quiz answers, the number of incorrect quiz answers, the number of times the learner repeated a module, the number of times a learner repeated the training lesson, and the like.

In an embodiment, the performance measures 128 can be used to monitor the performance of an individual learner. In another embodiment, the performance measures 128 can be used to monitor the performance of a plurality of learners. For example, in an academic setting, a class or laboratory grade can be based, at least in part, on a formula applied to results of the performance measures 128. In another example, the training modules could be an academic assignment that is weighted for a grade, the weighting depending at least in part on the results of the performance measures 128. In another embodiment, the performance measures 128 provide feedback to the learners 102 preparing for licensure examinations or boards.

In block 910, the administrator 102 determines whether additional performance criteria are to be tracked. If there are additional performance measures 128, the process 900 returns to block 908. If not, the process 900 ends at block 912. In an embodiment, the process 900 provides a customizable training program for educational purposes.

Although embodiments described herein relate to chronic wound care, other embodiments do not relate to chronic wound care. In other embodiments, the customizable interactive training modules and tracked performance criteria can be used to provide a unique system and method of educational training for a variety of training topics.

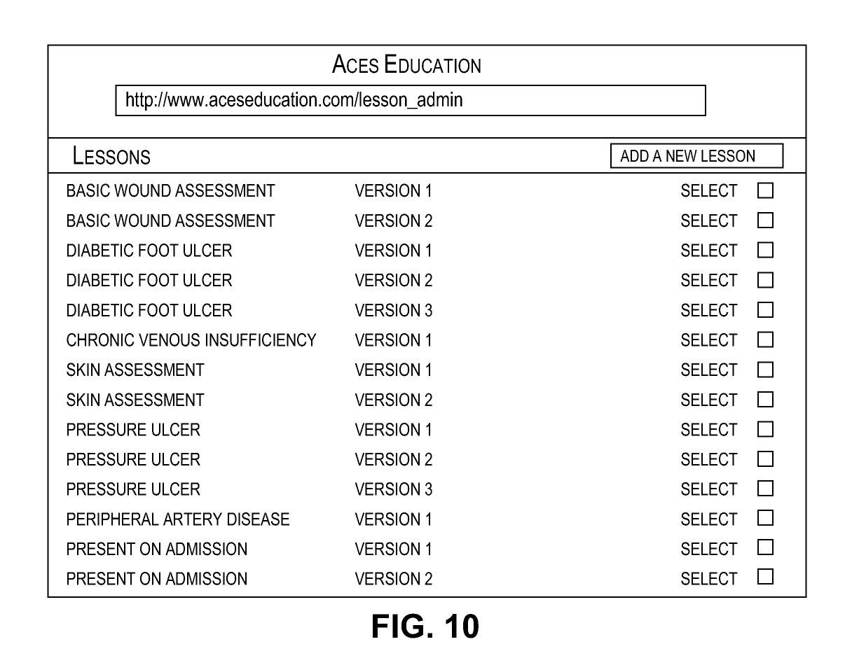

FIG. 10 is an exemplary screen shot of an administrator selection screen 1000 for building a virtual wound care training module 116, according to one embodiment.

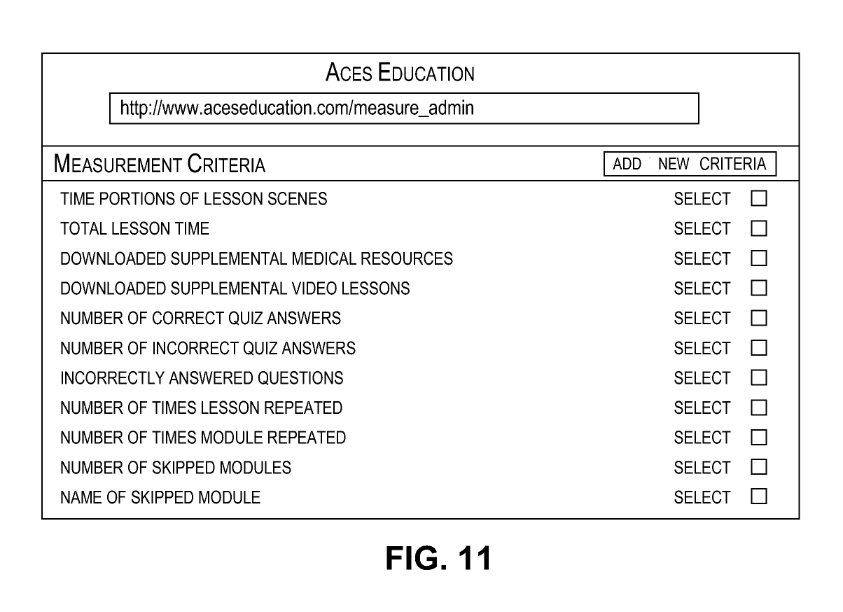

FIG. 11 is an exemplary screen shot of a virtual wound care training measures screen 1100 for determining which performance measures to track, how to evaluate the measured performance, and the like, according to one embodiment.

The various illustrative logical blocks, modules, and processes described herein may be implemented as electronic hardware, computer software, or combinations of both. To clearly illustrate this interchangeability of hardware and software, various illustrative components, blocks, modules, and states have been described above generally in terms of their functionality. However, while the various modules are illustrated separately, they may share some or all of the same underlying logic or code.

The various illustrative logical blocks, modules, and processes described herein may be implemented or performed by a machine, such as a computer, a processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor, a controller, microcontroller, state machine, combinations of the same, or the like. A processor may also be implemented as a combination of computing devices, e.g., a combination of a DSP and a microprocessor, a plurality of microprocessors or processor cores, one or more graphics or stream processors, one or more microprocessors in conjunction with a DSP, or any other such configuration.

The blocks or states of the processes described herein may be embodied directly in hardware, in a software module executed by a processor, or in a combination of the two. For example, each of the processes described above may also be embodied in, and fully automated by, software modules executed by one or more machines such as computers or computer processors. A module may reside in a computer-readable storage medium such as RAM memory, flash memory, ROM memory, EPROM memory, EEPROM memory, registers, hard disk, a removable disk, a CD-ROM, memory capable of storing firmware, or any other form of computer-readable storage medium known in the art. An exemplary computer-readable storage medium can be coupled to a processor such that the processor can read information from, and write information to, the computer-readable storage medium. In the alternative, the computer-readable storage medium may be integral to the processor. The processor and the computer-readable storage medium may reside in an ASIC.

Depending on the embodiment, certain acts, events, or functions of any of the processes or algorithms described herein can be performed in a different sequence, may be added, merged, or left out all together. Thus, in certain embodiments, not all described acts or events are necessary for the practice of the processes. Moreover, in certain embodiments, acts or events may be performed concurrently, e.g., through multi-threaded processing, interrupt processing, or via multiple processors or processor cores, rather than sequentially.

Conditional language used herein, such as, among others, “can,” “could,” “might,” “may,” “e.g.,” and from the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the logical blocks, modules, and processes illustrated may be made without departing from the spirit of the disclosure. As will be recognized, certain embodiments of the inventions described herein may be embodied within a form that does not provide all of the features and benefits set forth herein, as some features may be used or practiced separately from others.

What is claimed is:

1. A wound care system for providing users with interactive instruction for chronic wound care by presenting a visual depiction of a patient with a chronic wound and a visual depiction of wound characteristics, a cross-section of the wound and interactive wound care tools, the system comprising:
one or more computer processors configured to display a visual map having on-screen graphics representing at least one of tissue consistency, tissue texture, tissue temperature, tissue moisture, and tissue tenderness for a virtual chronic wound;
wherein at least some of the on-screen graphics represent visual cues for wound care such that a user is provided with a visual indication of at least one response of the virtual chronic wound to care the user virtually provides.

2. The system of claim 1, further comprising:
one or more computer processors configured to display a listing of virtual wound care scenes; and
one or more computer processors configured to build a custom training module based at least in part on user selections from the listing of the virtual wound care scenes.

3. The system of claim 2, further comprising one or more computer processors configured to track user performance measures, the user performance measures tracked while the user interacts with the custom training module.

4. The system of claim 3, wherein the user performance measures comprise at least one of an amount of time the user interacted with the custom training module, an amount of time the user interacted with a certain wound care scene, which supplemental medical resources the user downloaded, which supplemental video lessons the user selected, a number of correct quiz answers, a number of incorrect quiz answers, a number of times the user repeated the custom training module, and a number of times the user repeated the certain wound care scene.

5. The system of claim 1, further comprising one or more computer processors configured to display a plurality of interactive virtual wound care instructions, the plurality of interactive virtual wound care instructions comprising an optimal path, a suboptimal path, and a failure path.

6. A wound care system for providing users with interactive instruction for chronic wound care by presenting a visual depiction of a patient with a chronic wound and a visual depiction of wound characteristics, a cross-section of the wound and interactive wound care tools, the system comprising:
one or more computer processors configured to display a visual depiction of a virtual patient with a virtual chronic wound;
one or more computer processors configured to display a visual depiction of a cross-section of the virtual chronic wound;
one or more computer processors configured to display a visual depiction of a plurality of interactive wound care tools, at least one of the plurality of interactive wound care tools able to perform care for the virtual chronic wound; and
one or more computer processors configured to display a visual map having on-screen graphics representing at least one of tissue consistency, tissue texture, tissue temperature, tissue moisture, and tissue tenderness for the virtual chronic wound;
wherein at least some of the on-screen graphics represent visual cues for the virtual chronic wound such that a user is provided with a visual indication of at least one response of the virtual chronic wound to care the user virtually provides.

7. The system of claim 6, wherein the plurality of interactive wound care tools comprise at least one of examination tools, diagnostic tools, medicines, dressings, and adjunction modalities.

8. The system of claim 6, wherein the user is able to provide the care to the virtual chronic wound using at least one of the plurality of interactive wound care tools.

9. The system of claim 6, further comprising one or more computer processors configured to display interactive questions and answers instructing the user how to care for the virtual chronic wound.

10. The system of claim 6, further comprising one or more computer processors configured to update the display of the visual depiction of the cross-section of the virtual chronic wound to provide the user with a second visual indication of the at least one response of the virtual chronic wound to the care the user virtually provides.

11. The system of claim 10, further comprising one or more computer processors configured to update the display of the visual depiction of the virtual patient with the virtual chronic wound to provide the user with a third visual indication of the at least one response of the virtual chronic wound to the care the user virtually provides.

12. A method for providing a user with training in chronic wound care utilizing one or more computer processors, a memory storage device, a video display, and a user input device, the method comprising:
displaying a visual map having on-screen graphics representing at least one of tissue consistency, tissue texture, tissue temperature, tissue moisture, and tissue tenderness for a virtual chronic wound;
wherein at least some of the on-screen graphics represent visual cues for wound care such that a user is provided with a visual indication of at least one response of the virtual chronic wound to care the user virtually performs.

13. The method of claim 12 further comprising:
displaying a visual depiction of a virtual patient with the virtual chronic wound;
displaying a visual depiction of a cross-section of the virtual chronic wound; and
displaying a visual depiction of a plurality of interactive wound care tools, at least one of the plurality of interactive wound care tools able to perform the care for the virtual chronic wound.

14. The method of claim 13, further comprising displaying interactive questions and answers instructing the user how to care for the virtual chronic wound.

15. The method of claim 14, further comprising updating the visual depiction of the cross-section of the virtual chronic wound based at least in part on at least one response to the interactive questions to provide the user with a second visual indication of the at least one response of the virtual chronic wound to the care the user virtually performs.

16. The method of claim 15, further comprising updating the visual depiction of the virtual patient with the virtual chronic wound based at least in part on the at least one response to the interactive questions to provide the user with a third visual indication of the response of the virtual chronic wound to the care the user virtually performs.

17. The method of claim 12, further comprising:
displaying a listing of a plurality of virtual wound care scenes; and
building a custom training module based at least in part on user selections from the listing of the plurality of virtual wound care scenes.

18. The method of claim 17, further comprising tracking user performance measures, the user performance measures tracked while the user interacts with the custom training module.

19. The method of claim 18, wherein the user performance measures comprise at least one of an amount of time the user interacted with the custom training module, an amount of time the user interacted with a certain wound care scene from the plurality of virtual wound care scenes, which supplemental medical resources the user downloaded, which supplemental video lessons the user selected, a number of correct quiz answers, a number of incorrect quiz answers, a number of times the user repeated the custom training module, and a number of times the user repeated the certain wound care scene from the plurality of virtual wound care scenes.

20. The method of claim 12, further comprising displaying a plurality of interactive virtual wound care instructions, the virtual wound care instructions including an optimal path, a suboptimal path, and a failure path.
